(19) United States
(12) Patent Application Publication
(10) Pub. No.: US 2010/0175131 A1
(43) Pub. Date: Jul. 8, 2010

(54) METHOD AND SYSTEM FOR NETWORK PROTECTION AGAINST CYBER ATTACKS

(75) Inventor: Victor I. Sheymov, Vienna, VA (US)

Correspondence Address: The Villamar Firm PLLC, 3424 Washington Drive, Falls Church, VA, 22041, US

(73) Assignee: INVICTA NETWORKS, INC, Reston, VA (US)

(21) Appl. No.: 12/602,148

(22) PCT Filed: May 28, 2008
(86) PCT No.: PCT/US08/64950

§ 371 Date: Feb. 16, 2010

Related U.S. Application Data
(60) Provisional application No. 60/924,705, filed on May 29, 2007.

(51) Int. Cl. H04L 9/00; H04L 12/22

(52) U.S. Cl. 726/22; 709/223

(57) ABSTRACT

A method, system, and device for protecting networking computers or devices from cyber attacks, including periodically changing cyber coordinates of a communications network or system; communicating the changed cyber coordinates to corresponding or reciprocal networks and/or devices so they can maintain communications; detecting a cyber attack or receiving notification from the corresponding or reciprocal networks and/or devices of a cyber attack; and changing the cyber coordinates of the network or system upon such detection or notification and communicating the changed cyber coordinates to the corresponding or reciprocal networks and/or devices.

### CROSS REFERENCE TO RELATED DOCUMENTS

The present invention claims benefit of priority to U.S. Provisional Patent Application Ser. No. 60/924,705 of Sheymov, entitled “METHOD AND SYSTEM FOR NETWORK PROTECTION AGAINST CYBER ATTACKS,” filed on May 29, 2007, the entire disclosure of which is hereby incorporated by reference herein.

### BACKGROUND OF THE INVENTION

1. Field of the Invention

The present invention generally relates to system and methods for protection of communications networks, and more particularly to a system and method for improved protection of communications networks from cyber attacks, and the like.

2. Discussion of the Background

In recent years, the continuing vulnerability of computers to hacking attacks, combined with significant increase of the number of computers using the Internet leads to the increasing potential power of cyber attacks, such as Denial-of-Service (DoS), and particularly Distributed DoS (DDoS), attacks, and the like. Protection systems and methods have been employed for addressing such attacks. However, such systems, although providing protection at the network or system level, become less effective against more powerful attacks at the levels that could be potentially achieved by the massive DDoS attacks.

### SUMMARY OF THE INVENTION

Therefore, there is a need for a method, system, and device that address the above and other problems with methods and systems for protection from cyber attacks. The above and other needs are addressed by the exemplary embodiments of the present invention, which provide a method, system, and device for network protection against cyber attacks, such as Denial-of-Service (DoS), and particularly Distributed DoS (DDoS), attacks, and the like.

Accordingly, in exemplary aspects of the present invention, a method, system, and device for protecting networking computers or devices from cyber attacks are provided, including periodically changing cyber coordinates of a communications network or system; communicating the changed cyber coordinates to corresponding or reciprocal networks and/or devices so they can maintain communications; detecting a cyber attack or receiving notification from the corresponding or reciprocal networks and/or devices of a cyber attack; and changing the cyber coordinates of the network or system upon such detection or notification and communicating the changed cyber coordinates to the corresponding or reciprocal networks and/or devices. For example, such a defensive move based on changing cyber coordinates can be made periodically, deterministically or randomly, or based on an event, such as a cyber attack, and the like. Advantageously, protection against a powerful DDoS attack is shifted upstream from the target and delegated to more powerful communications devices, such as routers, and the like.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates a background art IP version 4 (IPv4) address;

FIG. 2 illustrates an exemplary system for network protection against cyber attacks;

FIG. 3 further illustrates the exemplary system of FIG. 2 for network protection against cyber attacks; and

FIG. 4 illustrates an exemplary process for network protection against cyber attacks.

### DETAILED DESCRIPTION

The present invention includes the recognition that the vulnerability of computers, for example, to the “flooding” type of Denial-of-Service (DoS), and particularly Distributed DoS (DDoS), cyber attacks, and the like, is based on a fundamental premise that the time required to process a packet in order to determine its validity is greater than time required to generate a “junk” packet used for the cyber attack. For example, in the case of the DDoS attack, this means that a large number of even relatively slow computers can generate and send more junk packets than a relatively more powerful computer can process. In other words, the defender of such a cyber attack is clearly at a computational disadvantage.

With the rapidly increasing numbers of Internet-connected computers, the computational disadvantage of a defender of cyber attacks is getting even more pronounced. This, in turn, increases vulnerability of important and even vital systems or networks, such as Systems Control And Data Acquisition (SCADA), systems or networks, and the like. Dealing with this vulnerability and the underlying computational disadvantage, by simply increasing the power of the computers performing the traditional functions, such as authentication, and the like, does not seem to be feasible.

The exemplary embodiments solve the above and other problems by employing the principle of Variable Cyber Coordinates (VCCs) to upstream networks or systems. VCCs for a transmitter and receiver employed in a protected network or system are not constant, but rather are constantly, and rapidly changing, wherein new coordinates are communicated only to authorized parties. The Cyber Coordinates can include any suitable address, such as a computer IP address or port, a telephone number, a Media Access Control (MAC) address, Ethernet Hardware Address (EHA), and the like, employed in any suitable communications system or network, and the like. By employing the principle of VCCs to upstream networks or systems, according to the exemplary embodiments, advantageously, it is possible to alleviate the problem created by cyber attacks, including a large number of DDoS attacking computers, and the like, by moving such a defensive mechanisms “upstream” and simplifying the attack detection algorithms.

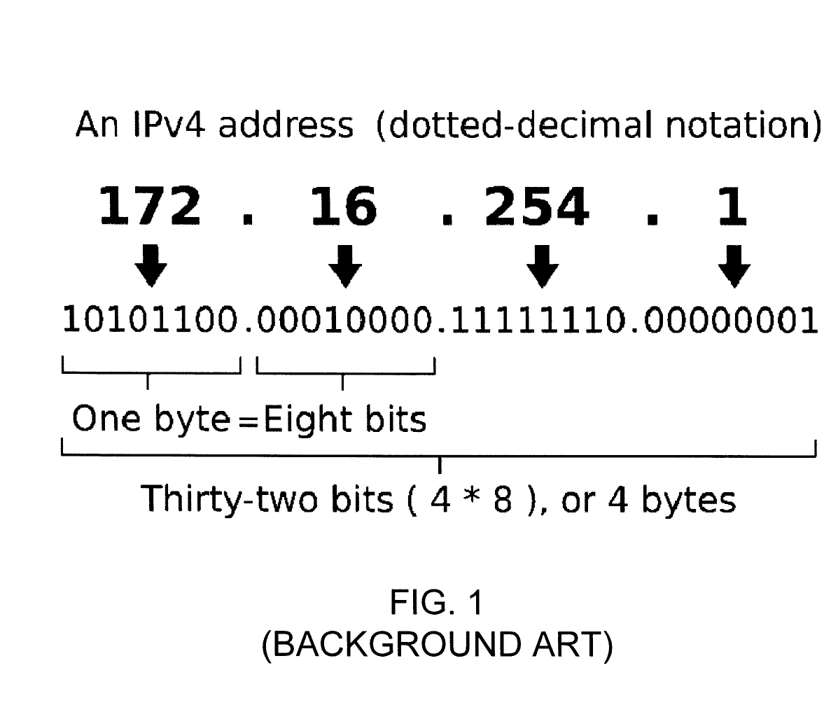

Indeed, in order to launch an attack, the attacker must first know the target's cyber coordinates. Even if the attack is directed not at a single computer, but at a network, the attacker must know the network's cyber coordinates, such as the IP address of the gateway, and the like. The exemplary protection method and system provide such information only to authorized systems or networks, and deny it to all other systems or networks. In other words, the exemplary system randomizes the appropriate portion of the protected network's cyber coordinates, such as the IP addresses, and the like, and communicates them only to authorized parties, for example, in encrypted manner. Accordingly, such cyber coordinates can include IP version 4 (IPv4) addresses, as shown in FIG. 1, IP version 6 (IPv6) addresses, or any other suitable communications protocols, and the like. Furthermore, such cyber coordinates are periodically changed and the new, currently valid cyber coordinates are communicated only to authorized parties. Such a change of cyber coordinates can be performed in any suitable manner, for example, including on a time basis (e.g., every second, minute, hour, day, week, month, year, or part thereof, etc.), deterministically or randomly, as a response to an event, such as an attack or some other occurrence, and the like.

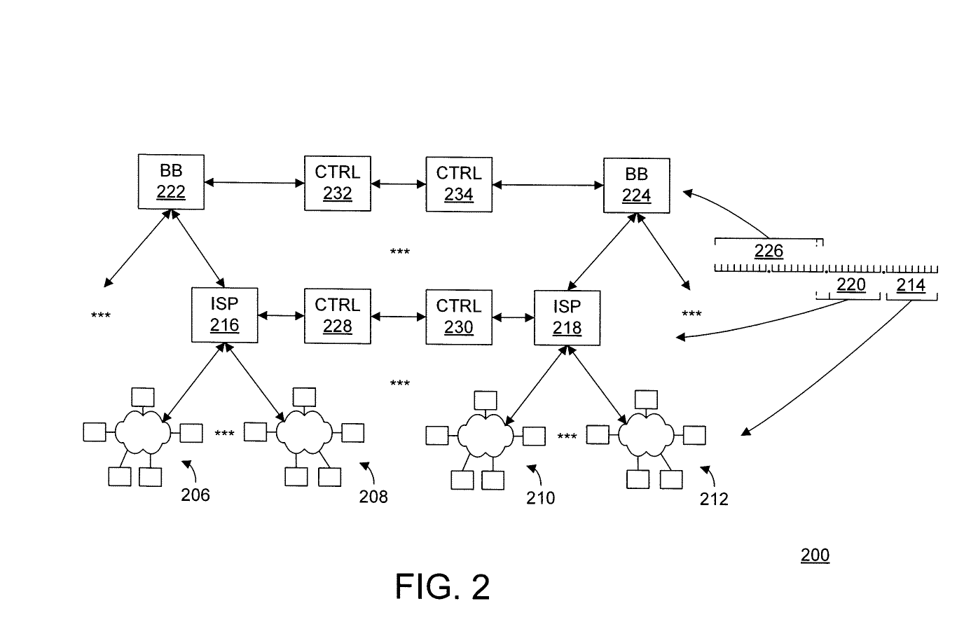

Referring now to the drawings, FIG. 2 thereof illustrates an exemplary system 200 for network protection against cyber attacks. In FIG. 2, the exemplary system 200 can include two or more participating Internet Service Providers (ISPs) 216 and 218 and/or telecommunications entities 222 and 224 that handle traffic for two or more protected networks or systems 206-212. For example, each protected network or system 206-212 has an assigned IP space of x bits 214, such as the 8 bits for an IPv4 Class C network. The networks or systems 206-212 typically handle these x bits 214, for example, assigning them to the IP address space employed by the one or more computers or devices of the networks or systems 206-212. The ISPs 216 and 218, on the other hand, deliver packets to the gateways of the networks or systems 206-212, and usually handle a number of networks or systems within its allocated higher y bits 220 of the IP address space. Accordingly, the ISPs 216 and 218 handle the next y bits 220 of the IP address space for its customers, i.e., the networks or systems 206-212. Usually this happens with broader bandwidth than as with the bandwidth of the networks or systems 206-212. The ISPs 216 and 218 receive packets destined to the networks or systems 206-212 from respective telecommunications entities 222 and 224 handling the backbone (e.g., Internet backbone) services for the ISPs 216 and 218. The ISPs 216 and 218 then handle (e.g., route) the packets within their respective assigned y bits 220. Often, these ISP-handled bits 220 number 8 or 9 bits, leaving the rest of the IP address space 226 (e.g., 15 or 16 bits for IPv4) for the telecommunications entities 222 and 224 handling the backbone services.

In an exemplary embodiment, the ISPs 216 and 218, the telecommunications entities 222 and 224 or any other suitable entity that handles traffic for a customer network or system performs the VCC function, as described above, for example, including randomizing the cyber coordinates of the protected networks, such as their IP address spaces 226, 220 and 214, and the like, and distributing them on a need-to-know basis, e.g., only to authorized parties. Such functionality can be performed, for example, by controllers 228 and 330 for the respective ISPs 216 and 218, and/or by controllers 232 and 234 for the respective telecommunications entities 222 and 224.

In an example for the Internet, if there are two ISPs 216 and 218 protecting their customers 206-212, they would inform each other of the current valid cyber coordinates of relevant customers 206-212 via the controllers 228 and 230, for enabling secure communications and for preventing cyber attacks. The routers and switches of the ISPs 216 and 218, being programmed accordingly, would direct communications traffic to the proper destinations. Similarly, two telecommunications entities 222 and 224 protecting their customers 216-218, would inform each other of the current valid cyber coordinates of relevant customers 216-218 via the controllers 232 and 234, for enabling secure communications and for preventing cyber attacks. The routers and switches of the telecommunications entities 222 and 224, being programmed accordingly, would direct communications traffic to the proper destinations.

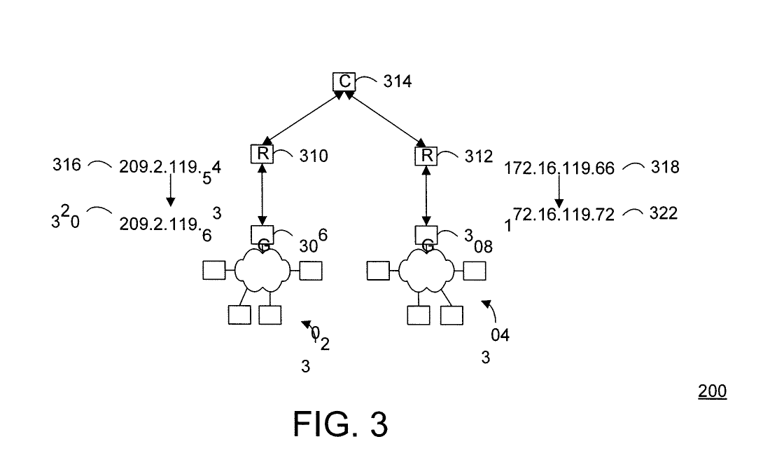

FIG. 3 further illustrates the exemplary system 200 of FIG. 2 for network protection against cyber attacks. In FIG. 3, one or more networks or systems 302 and 304 communicate with each other via gateways 306 and 308, and routers 310 and 312, which provide IP addresses 316 and 318, based on instructions from a controller 314. When one or more of the networks or systems 302 and 304 detect a cyber attack, such as a flooding attack, and the like, the controller 314 via the routers 310 and 312 can change the IP addresses 316 and/or 318 to IP addresses 320 and/or 322, as needed, so that the flooding packets can be dropped. In an exemplary embodiment, the IP addresses of the one or more networks or systems 302 and 304 can remain static, until a cyber attack is detected, at which time the IP addresses can be changed. In further exemplary embodiments, the IP addresses can be changed, for example, based on any suitable time, event, parameter, and the like. Examples of possible systems 302 or 306 that can detect a cyber attack can include InvisiLAN systems (e.g., as further described on the World Wide Web at invictanetworks.com/pdf/invisilantech.pdf), and the like.

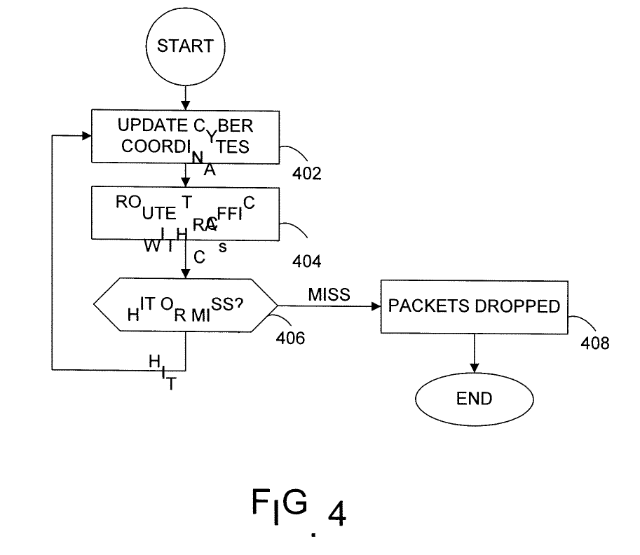

Accordingly, with the exemplary system 200, it is difficult for an attacker to launch a targeted attack without knowing the cyber coordinates of the target. FIG. 4 illustrates an exemplary process 400 for network protection against cyber attacks. In FIG. 4, at step 402, the cyber coordinates are updated and at step 404 traffic is routed using the updated cyber coordinates. If the attacker, however, still launches an attack without knowing the target's cyber coordinates, the attacker will “hit” the target or miss the target, as shown in step 406. In the case of a miss, at step 408 the attacking packets can be “dropped” (e.g., by the ISP controllers, routers, switches, etc., typically capable of handling a high volume of traffic in an “upstream,” fast environment, thus protecting the customer's usually slower gateway). If, however, the attacker guesses the target network's current cyber coordinates and “hits” the target, as shown in step 406, sensing the attack, the network's cyber coordinates can be changed (e.g., immediately or based on a predetermined number of attacks, and the like) at step 402 (e.g., via the ISP's controllers, routers, switches, etc.) and the packets now missing the target can be dropped at step 408 at the upstream location. A similar approach, as described above, can be employed within any suitable address space, such the address space of the telecommunications entities 322 and 324, and the like.

As noted above, in an exemplary embodiment, the respective security controllers 228-234 of the ISPs 216 and 218 and/or the telecommunications entities 222 and 224 can update the routers, switches, and the like, of the ISPs 216 and 218, and/or the telecommunications entities 222 and 224, based on the changes in the protected network's cyber coordinates. In an exemplary embodiment, such controllers, switches, routers, and the like, can be programmed to drop attacking packets without notification, advantageously, in order to speed up the response time. As will be appreciated by those skilled in the relevant art(s), the exemplary embodiments can be employed at any suitable upstream and/or downstream location(s) with participation of the relevant entitie(s).

The above-described devices and subsystems of the exemplary embodiments can be accessed by or included in, for example, any suitable clients, workstations, PCs, laptop computers, PDAs, Internet appliances, handheld devices, cellular telephones, wireless devices, other devices, and the like, capable of accessing or employing the new architecture of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the devices and subsystems of the exemplary embodiments are for exemplary purposes, as many variations of the specific hardware used to implement the exemplary embodiments are possible, as will be appreciated by those skilled in the relevant art(s). For example, the functionality of one or more of the devices and subsystems of the exemplary embodiments can be implemented via one or more programmed computer systems or devices.

To implement such variations as well as other variations, a single computer system can be programmed to perform the special purpose functions of one or more of the devices and subsystems of the exemplary embodiments. On the other hand, two or more programmed computer systems or devices can be substituted for any one of the devices and subsystems of the exemplary embodiments. Accordingly, principles and advantages of distributed processing, such as redundancy, replication, and the like, also can be implemented, as desired, to increase the robustness and performance of the devices and subsystems of the exemplary embodiments.

The devices and subsystems of the exemplary embodiments can store information relating to various processes described herein. This information can be stored in one or more memories, such as a hard disk, optical disk, magneto-optical disk, RAM, and the like, of the devices and subsystems of the exemplary embodiments. One or more databases of the devices and subsystems of the exemplary embodiments can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases thereof.

All or a portion of the devices and subsystems of the exemplary embodiments can be conveniently implemented using one or more general purpose computer systems, microprocessors, digital signal processors, micro-controllers, and the like, programmed according to the teachings of the exemplary embodiments of the present inventions, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments can be implemented on the World Wide Web. In addition, the devices and subsystems of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present inventions can include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the devices and subsystems of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of claims of the present invention.

1. A method for protecting networking computers or devices from cyber attacks, the method comprising:
periodically changing cyber coordinates of a communications network or system;
communicating the changed cyber coordinates to corresponding or reciprocal networks and/or devices of the communications network or system so they can maintain communications;
detecting a cyber attack or receiving notification from the corresponding or reciprocal networks and/or devices of a cyber attack; and
changing the cyber coordinates of the network or system upon the detection or notification and communicating the changed cyber coordinates to the corresponding or reciprocal networks and/or devices.

2. The method of claim 1, wherein the communications network or system is an Internet Service Provider communications network or system.

3. The method of claim 1, wherein the communications network or system is an Internet backbone communications network or system.

4. The method of claim 1, wherein the cyber coordinates are IPv4 or IPv6 addresses, or an address of a communications protocol.

5. The method of claim 1, wherein the cyber attack includes a Denial-of-Service (DoS) attack, including a Distributed DoS (DDoS) attack.

6. The method of claim 1, wherein a defensive move based on changing the cyber coordinates can be made one of periodically, deterministically, randomly, and based on an event, including a cyber attack.

7. A computer-implemented system for protecting networking computers or devices from cyber attacks, the system comprising:
means for periodically changing cyber coordinates of a communications network or system;
means for communicating the changed cyber coordinates to corresponding or reciprocal networks and/or devices of the communications network or system so they can maintain communications;
means for detecting a cyber attack or receiving notification from the corresponding or reciprocal networks and/or devices of a cyber attack; and
means for changing the cyber coordinates of the network or system upon the detection or notification and communicating the changed cyber coordinates to the corresponding or reciprocal networks and/or devices.

8. The system of claim 7, wherein the communications network or system is an Internet Service Provider communications network or system.

9. The system of claim 7, wherein the communications network or system is an Internet backbone communications network or system.

10. The system of claim 7, wherein the cyber coordinates are IPv4 or IPv6 addresses, or an address of a communications protocol.

11. The system of claim 7, wherein the cyber attack includes a Denial-of-Service (DoS) attack, including a Distributed DoS (DDoS) attack.

12. The system of claim 7, wherein a defensive move based on changing the cyber coordinates can be made one of periodically, deterministically, randomly, and based on an event, including a cyber attack.

13. A computer program product for protecting networking computers or devices from cyber attacks, and including one or more computer readable instructions embedded on a tangible computer readable medium and configured to cause one or more computer processors to perform the steps of:
periodically changing cyber coordinates of a communications network or system;
communicating the changed cyber coordinates to corresponding or reciprocal networks and/or devices of the communications network or system so they can maintain communications;
detecting a cyber attack or receiving notification from the corresponding or reciprocal networks and/or devices of a cyber attack; and
changing the cyber coordinates of the network or system upon the detection or notification and communicating the changed cyber coordinates to the corresponding or reciprocal networks and/or devices.

14. The computer program product of claim 13, wherein the communications network or system is an Internet Service Provider communications network or system.

15. The computer program product of claim 13, wherein the communications network or system is an Internet backbone communications network or system.

16. The computer program product of claim 13, wherein the cyber coordinates are IPv4 or IPv6 addresses, or an address of a communications protocol.

17. The computer program product of claim 13, wherein the cyber attack includes a Denial-of-Service (DoS) attack, including a Distributed DoS (DDoS) attack.

18. The computer program product of claim 13, wherein a defensive move based on changing the cyber coordinates can be made one of periodically, deterministically, randomly, and based on an event, including a cyber attack.
